(19) United States
(12) Patent Application Publication
(10) Pub. No.: US 2025/0210822 A1
(43) Pub. Date: Jun. 26, 2025

(54) WIRING MODULE

(71) Applicant: NIPPON MEKTRON, LTD., Tokyo (JP)

(72) Inventors: Yuki KOMURO, Tokyo (JP); Tomoki KANAYAMA, Tokyo (JP)

(73) Assignee: NIPPON MEKTRON, LTD., Tokyo (JP)

(21) Appl. No.: 18/898,588

(22) Filed: Sep. 26, 2024

(30) Foreign Application Priority Data
Dec. 22, 2023 (JP) 2023-217044

(51) Int. Cl. H01M 50/519; H01M 50/516

(52) U.S. Cl. CPC H01M 50/519; H01M 50/516

(57) ABSTRACT

Provided is a wiring module including a flexible printed board; and a metal piece, in which the flexible printed board has a land and a wiring connected to the land, the metal piece has an upper surface, a lower surface, a through-hole, and a projecting portion, the lower surface of the metal piece is solder-joined to the land, the through-hole is formed in a thickness direction of the metal piece, the projecting portion is formed so as to project from at least part of an edge of the through-hole to above the upper surface of the metal piece, the projecting portion has a plated portion and a non-plated portion, the plated portion is provided at an inner peripheral surface of the projecting portion facing the through-hole, and the non-plated portion is provided at an end surface of a projecting end of the projecting portion.

### CROSS-REFERENCE TO RELATED APPLICATION

This application claims priority from Japanese Patent Application No. 2023-217044 filed with the Japan Patent Office on Dec. 22, 2023, the entire content of which is hereby incorporated by reference.

### BACKGROUND

### 1. Technical Field

The present disclosure relates to a wiring module including a flexible printed board.

### 2. Related Art

JP-A-2022-114561 describes that a metal piece (described as a metal plate in JP-A-2022-114561) is soldered to a land provided at a flexible printed board. It has been known that the land of the flexible printed board and the metal piece are joined to each other by solder joining such as soldering.

It has also been known that the metal piece is made of a material from which a passive film is easily formed, such as nickel or aluminum, and is plated.

For example, a portion of the metal piece connected to the land via solder is plated with tin as plating exhibiting excellent solderability (i.e., soft coating film and low melting point).

A fillet formed on the plated portion by solder joining is visually checked by an inspector, and in this manner, it is determined whether or not solder joining is properly performed.

It has been known that a through-hole is formed in the metal piece and the inner edge surface of the through-hole and the land are connected to each other with solder.

### SUMMARY

A wiring module according to an embodiment of the present disclosure includes a flexible printed board; and a metal piece, in which the flexible printed board has a land and a wiring connected to the land, the metal piece has an upper surface, a lower surface, a through-hole, and a projecting portion, the lower surface of the metal piece is solder-joined to the land, the through-hole is formed inside an outer peripheral edge of the metal piece in a thickness direction of the metal piece, the projecting portion is formed so as to project from at least part of an edge of the through-hole to above the upper surface of the metal piece, the projecting portion has a plated portion and a non-plated portion, the plated portion is provided at an inner peripheral surface of the projecting portion facing the through-hole, and the non-plated portion is provided at an end surface of a projecting end of the projecting portion.

### BRIEF DESCRIPTION OF THE DRAWINGS

FIG. 1 is a plan view showing a wiring module according to a first embodiment and a plurality of battery cells connected to the wiring module;

FIG. 2 is a plan view showing a state of an end portion of an extending portion of a flexible printed board and a protruding portion of a metal plate being connected to each other;

FIG. 3 is a schematic view for describing a state of the flexible printed board and the metal plate being connected to each other, which shows a projecting portion provided at the metal plate;

FIG. 4 is an end view showing the projecting portion and a fillet along an IV-IV line in FIG. 3;

FIG. 5 is an end view showing a projecting portion and fillets according to a first modification, which corresponds to FIG. 4;

FIG. 6 is an end view showing a projecting portion and a fillet according to a second modification, which corresponds to FIG. 4;

FIG. 7 is a sectional view showing a projecting portion according to a third modification along the IV-IV line in FIG. 3;

FIG. 8 is a schematic perspective view showing a projecting portion and a through-hole according to a second embodiment; and

FIG. 9 is an end view showing the projecting portion and a fillet along an IX-IX line in FIG. 8.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, if not only the inner edge surface of the through-hole of the metal piece but also the surface of the metal piece opposite to the side on which the metal piece faces the land are continuously plated, the fillet may be formed to the surface of the metal piece opposite to the side on which the metal piece faces the land. In this case, the fillet formed on the inner edge surface (portion facing the through-hole) of the through-hole and targeted for visual inspection in solder joining may be thin. The thickness of the fillet may influence the visual inspection (visual inspection by visual check, an image, or an X-ray) in solder joining. For this reason, in the related art, there is still room for improvement in enhancing the reliability of the visual inspection in solder joining.

The present disclosure has been made in view of the above-described problems, and provides a wiring module capable of enhancing the reliability of the visual inspection in solder joining.

The wiring module according to the present disclosure includes a flexible printed board; and a metal piece, in which the flexible printed board has a land and a wiring connected to the land, the metal piece has an upper surface, a lower surface, a through-hole, and a projecting portion, the lower surface of the metal piece is solder-joined to the land, the through-hole is formed inside an outer peripheral edge of the metal piece in a thickness direction of the metal piece, the projecting portion is formed so as to project from at least part of an edge of the through-hole to above the upper surface of the metal piece, the projecting portion has a plated portion and a non-plated portion, the plated portion is provided at an inner peripheral surface of the projecting portion facing the through-hole, and the non-plated portion is provided at an end surface of a projecting end of the projecting portion.

According to the wiring module of the present disclosure, the reliability of the visual inspection in solder joining can be enhanced.

Hereinafter, a wiring module according to an embodiment of the present disclosure will be described with reference to the drawings.

Note that the embodiment described below is merely one example for the sake of easy understanding of the present disclosure and is not intended to limit the present disclosure. That is, the shapes, dimensions, arrangements, etc. of members described below may be changed or modified without departing from the gist of the present disclosure, and needless to say, the present disclosure includes equivalents thereof.

Note that the drawings used in the present embodiment are drawings showing, as an example, the configuration and shape of the wiring module of the present disclosure and the arrangement of each member forming the wiring module, and are not intended to limit the present disclosure. Moreover, the drawings used in the present embodiment do not precisely show the length, width, and height, i.e., the dimensional ratio, of the wiring module.

Note that in the drawings used in the present embodiment, the same reference numerals are used to represent similar components and description thereof may be omitted as necessary.

### First Embodiment

### <Outline>

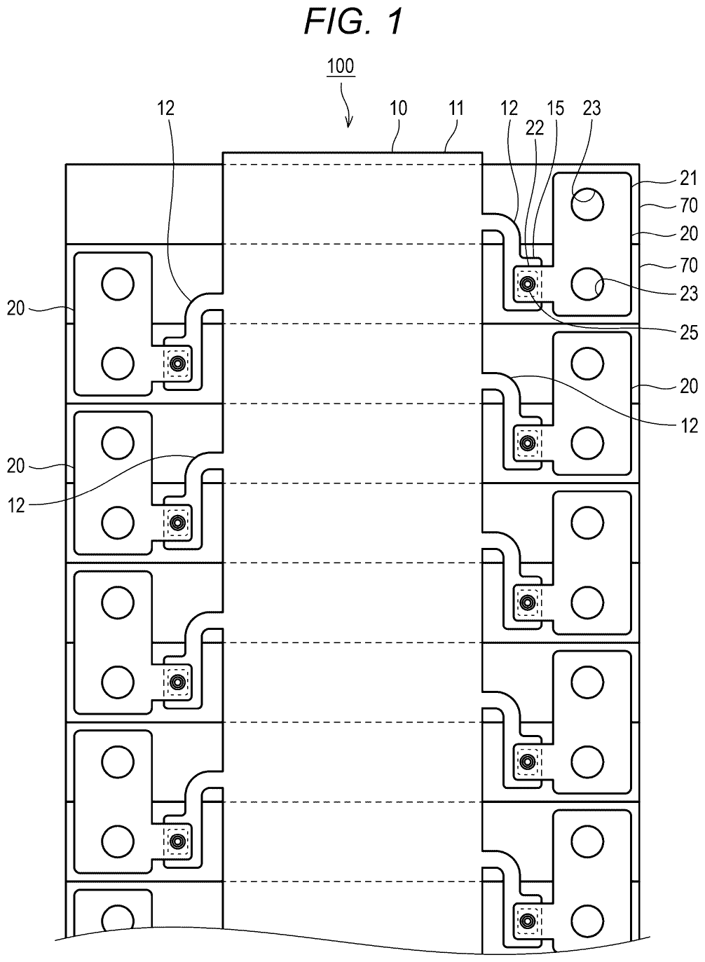

First, regarding the outline of the present disclosure, a wiring module 100 according to a first embodiment will be described as an example mainly with reference to FIGS. 1 to 4.

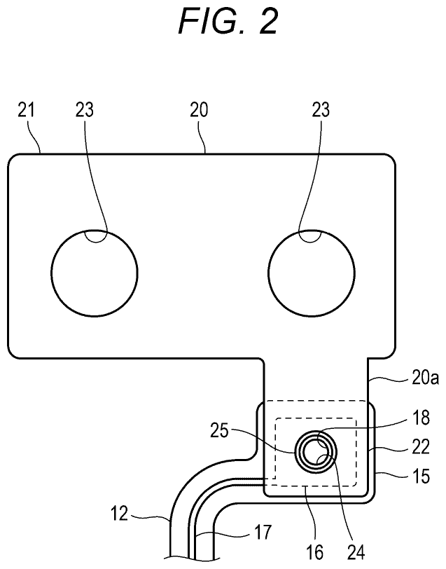

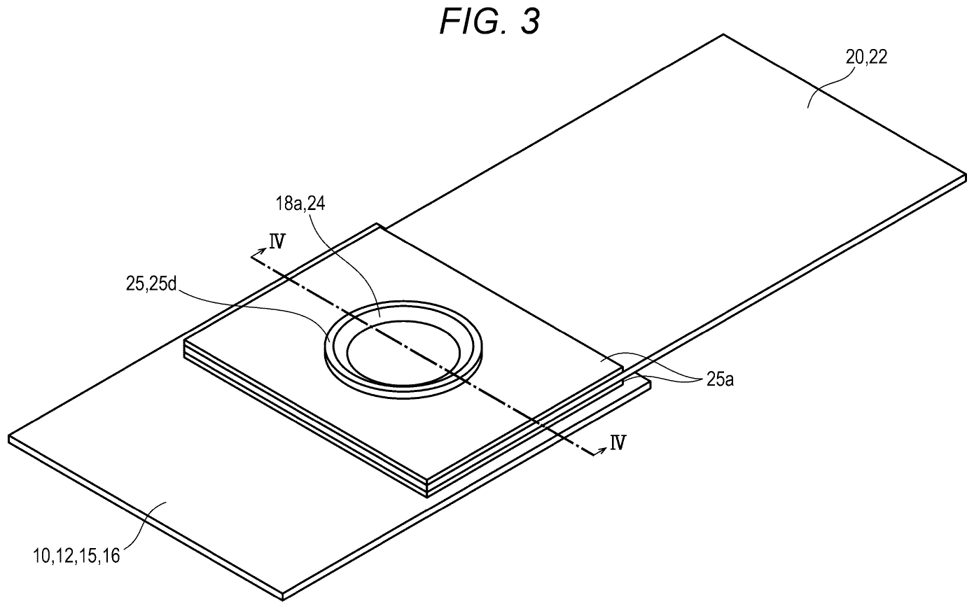

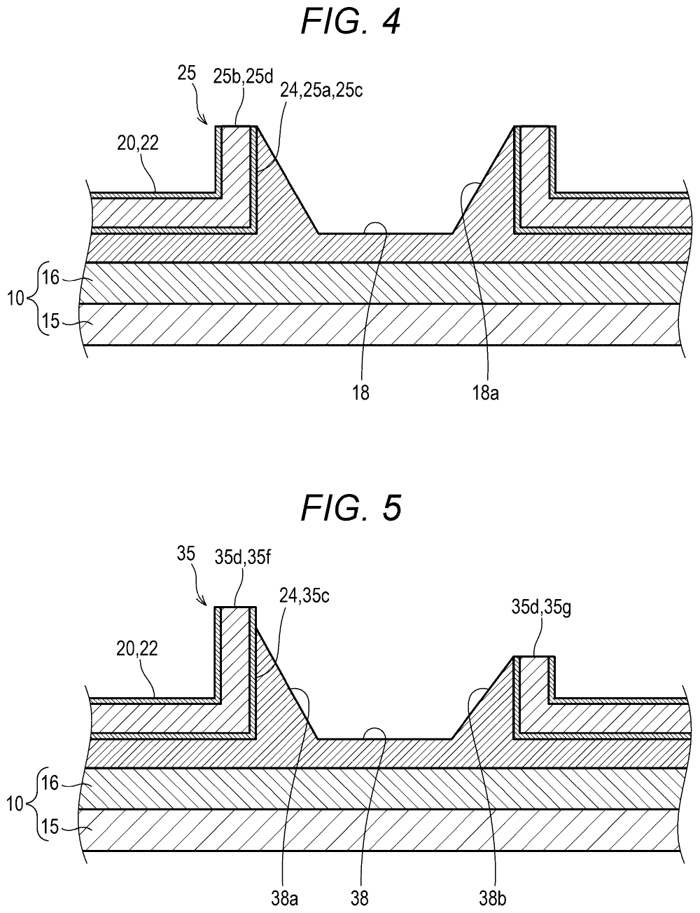

FIG. 1 is a plan view showing the wiring module 100 according to the first embodiment and a plurality of battery cells 70 connected to the wiring module 100. FIG. 2 is a plan view showing a state of an end portion 15 of an extending portion 12 of a flexible printed board 10 and a protruding portion 22 of a metal plate 20 being connected to each other. FIG. 3 is a schematic view for describing a state of the flexible printed board 10 and the metal plate 20 being connected to each other, which shows a projecting portion 25 provided at the metal plate 20. FIG. 4 is an end view showing the projecting portion 25 and a fillet 18a along an IV-IV line in FIG. 3.

Note that in FIG. 1, a fixing member for fixing the metal plate 20 to the battery cell 70 is not shown.

Moreover, FIG. 2 shows, in closeup, one metal plate 20 and the end portion 15 of one extending portion 12 of the flexible printed board 10 corresponding to the one metal plate 20.

Further, FIG. 3 is the view mainly for describing the projecting portion 25 provided at a connection portion between the flexible printed board 10 and the metal plate 20, and shows part (the protruding portion 22 of FIG. 1) of the metal plate 20 and part (the end portion 15) of the flexible printed board 10. In FIG. 3, a plating thickness is shown thicker than an actual thickness.

As shown in FIGS. 1 and 2, the wiring module 100 according to the first embodiment includes the flexible printed board 10 having a plurality of wirings 17 (see FIG. 2) and a plurality of lands 16, and a plurality of metal pieces (metal plates 20). One end of each of the plurality of wirings 17 is connected to a corresponding one of the plurality of lands 16. The metal plate 20 is disposed so as to overlap with the land 16, and is solder-joined to the land 16. The metal plate 20 has an upper surface and a lower surface opposite to the upper surface in a thickness direction, and the lower surface of the metal plate 20 is solder-joined to the land 16.

As shown in FIGS. 2 to 4, the metal plate 20 has the projecting portion 25. The projecting portion 25 and a through-hole 24 are formed inside an outer peripheral edge 20a of the metal plate 20 in the thickness direction.

The projecting portion 25 is formed so as to project in the thickness direction from at least part of the edge of the through-hole 24 to the side opposite to the side on which the metal plate 20 is solder-joined to the land 16.

Specifically, the projecting portion 25 is formed so as to project from at least part of the edge of the through-hole 24 to above the upper surface of the metal plate 20. In the present embodiment, the projecting portion 25 is formed in such a manner that part of the metal plate 20 is bent upward.

In the example shown in FIG. 3, the projecting portion 25 projects from the entire edge (entire circumference of the inner peripheral surface of the projecting portion 25) of the through-hole 24 to above the upper surface of the metal plate 20, but the present disclosure is not limited thereto. The projecting portion 25 may project from at least part of the edge of the through-hole 24 to above the upper surface of the metal plate 20.

As shown in FIG. 4, the surface of the projecting portion 25 has a plated portion 25a and a non-plated portion 25b. The plated portion 25a is located at an inner wall portion 25c facing the through-hole 24 and forming the inner peripheral surface of the projecting portion 25, and the non-plated portion 25b is located at the end surface 25d of the projecting end of the projecting portion 25. In other words, in the present embodiment, the plated portion 25a is provided at the inner peripheral surface (surface of the projecting portion 25 on the through-hole 24 side) of the projecting portion 25. The non-plated portion 25b is provided at the upper surface of the projecting end of the projecting portion 25.

In description below, the upper side in the sectional view such as FIG. 4 may be referred to as one side, and the lower side may be referred to as the other side.

The metal plate 20 which is the “metal piece” in the present disclosure may be a bus bar connecting the plurality of battery cells 70 in series, or a metal tab (not shown) which is an intermediate member connected to a bus bar. In the present embodiment, an example where the metal plate 20 is the bus bar will be described. Note that the “metal plate” is not necessarily in a flat plate shape as a whole and a flat portion is only required to be provided at a portion of the metal piece solder-joined to the land 16. Further, the metal piece in the present disclosure is not limited to one related to the bus bar connected to the battery cells 70, and may be connected to a conductive member (for example, a lead) different from the bus bar.

The term “solder joining” in the present disclosure includes soldering and brazing. In the present embodiment, soldering will be described as an example.

As described above, the projecting portion 25 is formed at at least part of the edge of the through-hole 24 in the metal piece (metal plate 20), the plated portion 25a is located at the inner wall portion 25c forming the inner peripheral surface of the projecting portion 25, and the non-plated portion 25b is located at the end surface 25d of the projecting end. According to this configuration, the fillet 18a can be concentrated (gathered) on the inner wall portion 25c forming the inner peripheral surface of the projecting portion 25, as shown in FIG. 4. Thus, the fillet 18a can be easily detected in visual inspection.

Note that the visual inspection for the fillet 18a in solder joining may be inspection by an image inspection device, visual inspection by an inspector, or inspection with an X-ray inspection machine.

If the projecting portion 25 shown in FIGS. 3 and 4 is not provided and the projecting portion 25 is formed by bending the outer peripheral edge 20a of the metal piece (metal plate 20) shown in FIG. 2, the land 16 needs to be formed slightly larger than a joint portion between the metal plate 20 and the land 16 and the fillet 18a needs to be visually recognizable. On the other hand, in a case where the projecting portion 25 is provided at the edge of the through-hole 24 formed in the metal plate 20 and the fillet 18a is formed thereon as shown in FIGS. 3 and 4, a size relationship between the metal plate 20 and the land 16 can be arbitrarily set, and therefore, the degree of freedom in design can be enhanced.

Hereinafter, the present embodiment will be described in more detail.

As shown in FIG. 1, the wiring module 100 includes the flexible printed board 10 and the plurality of metal plates 20, and these metal plates 20 connect the plurality of battery cells 70 in series. The battery cell 70 is a secondary battery.

The flexible printed board 10 according to the present embodiment is used for monitoring a voltage by, for example, connecting the wiring 17 to the bus bar (metal plate 20) connecting the plurality of battery cells 70. For example, a connector is attached to the flexible printed board 10, and the flexible printed board 10 is connected to a measurement device, that performs various types of control, via the connector so that the voltage can be monitored.

As shown in FIG. 1, the flexible printed board 10 includes a flat plate-shaped body portion 11 and the plurality of extending portions 12 extending from the edge of the body portion 11.

The shape of the extending portion 12 is not particularly limited, but as one example, is a bent shape in plan view as shown in FIG. 1. The extending portion 12 has the end portion 15 at the tip end. The end portion 15 is formed wider than a base end portion of the extending portion 12 in plan view.

As one example, in the present embodiment, the entirety of the extending portion 12 is disposed on the same plane. The planar shape of the end portion 15 is not particularly limited, but as one example, is a rectangular shape (for example, rectangular shape with round corners) in the present embodiment.

As shown in FIGS. 2 and 4, the land 16 which is a thin film of a conductor such as metal is formed on the upper surface of the end portion 15. The planar shape of the land 16 is not particularly limited, but as one example, is a rectangular shape (for example, rectangular shape with round corners). In the case of the present embodiment, the area of the land 16 is smaller than the area of the protruding portion 22 of the metal plate 20. As shown in FIG. 2, as viewed in the thickness direction of the metal plate 20 (in plan view), the land 16 is within the outline (outer peripheral edge 20a of the metal plate 20) of the protruding portion 22 of the metal plate 20.

Note that in the present embodiment, the land 16 is formed so as to cover the upper surface of the end portion 15 of the flexible printed board 10 with no gap therebetween in a region including the through-hole 24 in plan view. According to this configuration, a region where the fillet 18a is formed can be limited to a region where the land 16 is formed, and when the metal plate 20 is joined to the land 16 with solder, the accuracy of the position of the metal plate 20 relative to the land 16 can be naturally favorably controlled by the surface tension of molten solder 18. Note that the present disclosure is not limited to such a configuration and part of the land 16 is not necessarily formed in the region including the through-hole 24 in plan view.

The flexible printed board 10 includes the plurality of wirings 17. The plurality of wirings 17 each extends from the body portion 11 to the end portions 15 of the extending portions 12 (see FIG. 2). For example, the wirings 17 are arranged in the extending portions 12 one by one. The lands 16 are formed at the end portions 15 one by one, and the tip end of each wiring 17 is connected to a corresponding one of the lands 16.

The metal plate 20 according to the present embodiment is the bus bar connecting the plurality of battery cells 70 in series, and for example, is formed in a flat plate shape. As shown in FIG. 2, the metal plate 20 has, for example, a body portion 21 and the protruding portion 22. The protruding portion 22 protrudes from the body portion 21 in plan view. In the example shown in FIG. 2, in plan view, the protruding portion 22 protrudes outward of the body portion 21 from the surface of the body portion 21 along the longitudinal direction thereof. The dimension of the protruding portion 22 in the direction along the longitudinal direction of the body portion 21 is smaller than the dimension of the body portion 21 in the longitudinal direction thereof.

The planar shape of the body portion 21 of the metal plate 20 is not particularly limited, but as one example, is a rectangular shape (for example, rectangular shape with round corners). The body portion 21 has two fixing holes 23. The two fixing holes 23 are for fixing the body portion 21 to two of the battery cells 70 located next to each other and electrically connecting the two battery cells 70 via the fixed body portion 21. Note that when the metal plate 20 is a metal tab connected to the bus bar, the metal plate 20 does not necessarily have the fixing holes 23.

The protruding portion 22 of the metal plate 20 is formed so as to protrude from the body portion 21 to connect the metal plate 20 to the land 16, which is provided at the flexible printed board 10, via the solder 18. The planar shape of the protruding portion 22 is not particularly limited, but as one example, is a rectangular shape (for example, rectangular shape with two round corners on the tip end side in the protruding direction).

The protruding portion 22 has the through-hole 24 and the projecting portion 25 projecting upward from the edge of the through-hole 24. The through-hole 24 penetrates the protruding portion 22 of the metal plate 20 in the thickness direction.

The number of through-holes 24 in each metal plate 20 is not particularly limited, but in the case of the present embodiment, each metal plate 20 (each protruding portion 22 thereof) has one through-hole 24.

The planar shape of the through-hole 24 is not particularly limited, but in the case of the present embodiment, is a circular shape, for example. Note that the planar shape of the through-hole 24 may be a rectangular shape and may be an arbitrary shape as described later. As shown in FIG. 4, the protruding portion 22 of each metal plate 20 is joined to the land 16 of a corresponding one of the extending portions 12 via the solder 18.

In the example shown in FIG. 3, the projecting portion 25 is formed over the entire circumference of the edge of the through-hole 24. Note that in FIG. 4, the projecting portion 25 is shown so as to bend at right angle from another portion of the protruding portion 22 formed continuously to the base end side of the projecting portion 25 and project upward, but the present disclosure is not limited to such a configuration. For example, a curved portion may be formed at such a bent portion. That is, the projecting portion 25 is not necessarily bent at right angle from the another portion, and may be curved and project upward, needless to say. The same also applies to later-described projecting portions 35, 45, 55, 65.

Partial plating is performed on at least part of a region of the metal plate 20 connectable to the flexible printed board 10.

As shown in FIGS. 3 and 4, the plated portion 25a is provided over the entire circumference of the inner peripheral surface of the projecting portion 25, and as shown in FIG. 4, the non-plated portion 25b is provided over the entire circumference of the end surface 25d of the projecting end at the edge of the through-hole 24.

As in the above-described configuration, since the plated portion 25a easily connectable with solder is provided over the inner peripheral surface of the projecting portion 25 and the non-plated portion 25b not easily connectable with solder is provided over the entire circumference of the end surface 25d of the projecting end, the fillet 18a can be easily formed in an annular shape. Thus, the strength of connection by solder joining (soldering) can be further enhanced by the fillet 18a formed in the annular shape.

The plated portion 25a according to the present embodiment is formed not only at the inner peripheral surface of the projecting portion 25, but also at a lower surface portion (portion on the side on which the protruding portion 22 is mounted on the land 16) of the protruding portion 22 formed continuously to the inner peripheral surface of the projecting portion 25. Further, the plated portion 25a is also formed at the outer peripheral surface of the projecting portion 25 and an upper surface portion of the protruding portion 22 formed continuously to such an outer peripheral surface.

### First Modification

The projecting portion 25 according to the first embodiment is shown so as to have a uniform height in FIG. 4, but the present disclosure is not limited to such a configuration.

Next, a projecting portion 35 according to a first modification will be described with reference to FIG. 5. FIG. 5 is an end view showing the projecting portion 35 and fillets 38a, 38b according to the first modification, which corresponds to FIG. 4.

As shown in FIG. 5, a portion 35f of the projecting portion 35 having the highest projecting height and a portion 35g of the projecting portion 35 having the lowest projecting height are provided so as to face each other. A positional relationship between the highest portion 35f and the lowest portion 35g is not limited to that in the example shown in FIG. 5. The lowest portion 35g is only required to be provided opposite to the highest portion 35f with respect to the center of the through-hole 24 in plan view (as viewed in the thickness direction of the metal plate 20 in FIG. 3).

Specifically, in the circular through-hole 24, the lowest portion 35g may be located relative to the highest portion 35f within an area of +90 degrees or more and −90 degrees or less with respect to the center of the through-hole 24. When the through-hole 24 and the projecting portion 25 are formed in quadrangular shapes, the highest portion 35f and the lowest portion 35g may be located on one and the other sides of two opposing sides of the quadrangular through-hole 24. Note that the circular through-hole 24 is not limited to an exact circle shape and may be an oval shape. The quadrangular through-hole 24 may be in a polygonal shape with five or more corners.

According to the above-described configuration, by making the projecting portion 35 have different projecting heights, the heights of the fillets 38a, 38b of solder 38 can be adjusted and the connection strength can be easily adjusted according to the position of the edge of the through-hole 24.

Specifically, the fillet 38a is formed over an area large in the projecting direction at a portion of an inner wall portion 35c connected to the highest portion 35f of the projecting portion 35, and the fillet 38b is formed over an area small in the projecting direction at a portion of the inner wall portion 35c connected to the lowest portion 35g of the projecting portion 35.

The projecting portion 35 in a circular shape in plan view (as viewed in the thickness direction) includes the highest portion 35f and the lowest portion 35g, and is continuously formed with different heights in the circumferential direction of the through-hole 24.

With this configuration, the entire fillet including the fillets 38a, 38b formed along the circular projecting portion 35 can be easily continuously formed in the circumferential direction of the through-hole 24, and stress concentration on the fillet can be easily suppressed.

### Second Modification

The end surface 25d of the projecting portion 25 in the first embodiment and the end surface 35d of the projecting portion 35 in the first modification are formed in parallel with the upper surface of the protruding portion 22 and the upper surface of the land 16, as shown in FIGS. 4 and 5. However, the present disclosure is not limited to such a configuration.

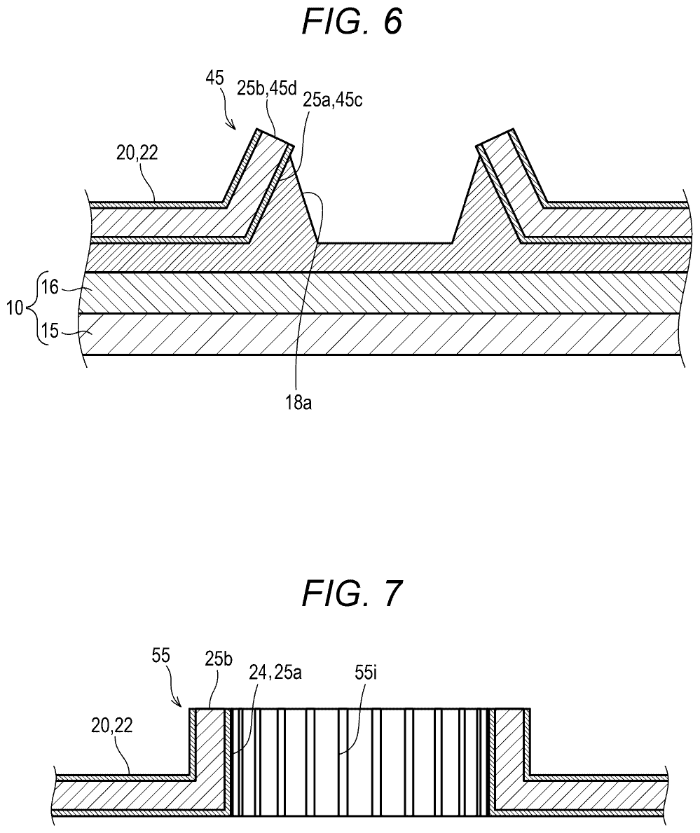

Next, a projecting portion 45 according to a second modification will be described with reference to FIG. 6.

FIG. 6 is an end view showing the projecting portion 25 and the fillet 18a according to the second modification, which corresponds to FIG. 4.

As shown in FIG. 6, an end surface 45d of the projecting end of the projecting portion 45 is formed so as to be inclined downward to the other side (lower side) in the thickness direction while extending toward the center of the through-hole 24. That is, the end surface 45d of the projecting end is inclined so as to approach the upper surface of the land 16 as extending toward the center of the through-hole 24.

According to the above-described configuration, even if the fillet 18a is temporarily located on the end surface 45d of the projecting portion 45 provided with the non-plated portion 25b, the weight of the fillet 18a itself acts toward the land 16 (downward) because the end surface 45d is inclined downward. Thus, the fillet 18a is easily movable to the plated portion 25a of the inner peripheral surface of the projecting portion 25.

Particularly, in the present modification, an inner wall portion 45c of the projecting portion 45 is formed so as to be inclined to the center of the through-hole 24 with respect to the direction parallel with the thickness direction of the metal plate 20.

With this configuration, an interval between the plated portion 25a of the inner peripheral surface of the projecting portion 25 and the land 16 is narrower than that in a case where the inner wall portion 45c of the projecting portion 45 projects parallel with the thickness direction of the metal plate 20, and therefore, joint force with the fillet 18a can be enhanced. Moreover, the angle of the downwardly-inclined end surface 45d of the projecting portion 45 with respect to the upper surface of the land 16 can be made greater.

The inner wall portion 45c of the projecting portion 45 is only required to be inclined even slightly to the center of the through-hole 24 with respect to the direction parallel with the thickness direction of the metal plate 20. Such inclination of the inner wall portion 45c is preferable because the region where the fillet 18a is formed can be ensured in the up-down direction in FIG. 6 and the lateral and depth directions parallel with the upper surface of the protruding portion 22 other than the projecting portion 45.

### Third Modification

Each of the projecting portion 25 according to the first embodiment, the projecting portion 35 according to the first modification, and the projecting portion 45 according to the second modification may have, in the inner peripheral surface thereof, a groove 55i described subsequently.

Next, a projecting portion 55 according to a third modification will be described with reference to FIG. 7.

FIG. 7 is a sectional view showing the projecting portion 55 according to the third modification along the IV-IV line in FIG. 3. Note that in FIG. 7, the width of the groove 55i is shown larger than an actual width for the sake of convenience in description of the configuration.

As shown in FIG. 7, the groove 55i is formed in the inner peripheral surface of the projecting portion 55. The groove 55i is recessed from the inner peripheral surface side to the outer peripheral surface side of the projecting portion 55, and extends in the projecting direction (up-down direction in FIG. 7). The depth of the recess as the groove 55i is formed shallower than the thickness of the plated portion 25a of the inner peripheral surface of the projecting portion 55.

The groove 55i is formed so as to be recessed inward in the thickness direction of the projecting portion 55 from the surface of the plated portion 25a. The phrase “extending in the projecting direction” means extension along the direction of extension of the inner peripheral surface of the projecting portion 55, and is not limited to linear extension in the projecting direction.

According to the above-described configuration, since the groove 55i is formed in the inner peripheral surface of the projecting portion 55, the fillet 18a enters the groove 55i, so that the strength of connection between the fillet 18a and the metal plate 20 can be enhanced. Further, since the recess as the groove 55i is formed shallower than the thickness of the plated portion 25a, and therefore, exposure of the metal plate 20 through the plated portion 25a can be suppressed.

Note that a plurality of grooves 55i is preferably formed over the entire circumference of the inner peripheral surface of the projecting portion 55 as shown in FIG. 7 because the strength of connection between the fillet 18a and the metal plate 20 can be uniformly enhanced over the entirety of the inner peripheral surface of the projecting portion 55.

Note that in FIG. 7, the width of the groove 55i in the left-right direction is shown larger than the thickness of the plated portion 25a, but the present disclosure is not limited to such a configuration and the width of the groove 55i may be equal to or less than the thickness of the plated portion 25a.

### Second Embodiment

The example where the projecting portion 25, 35, 45 according to the first embodiment projects upward from the entire circumference of the edge of the through-hole 24 formed in the circular shape in plan view has been described, but the present disclosure is not limited to such a configuration.

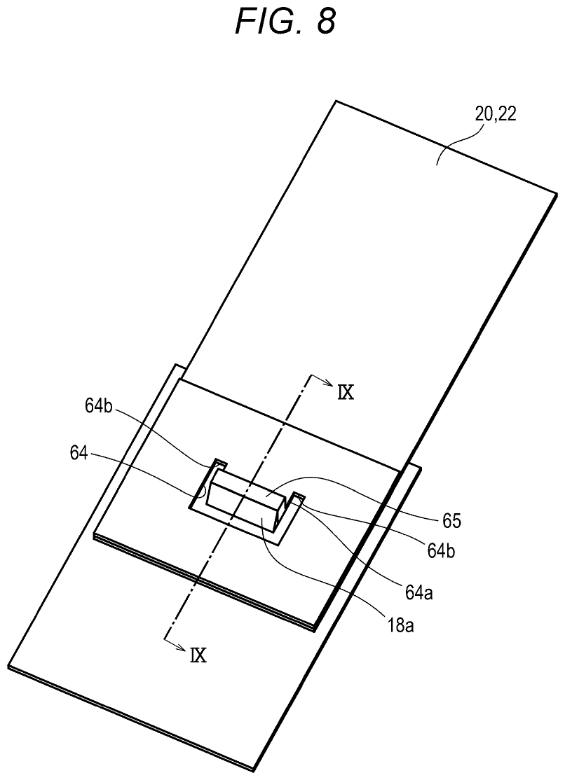

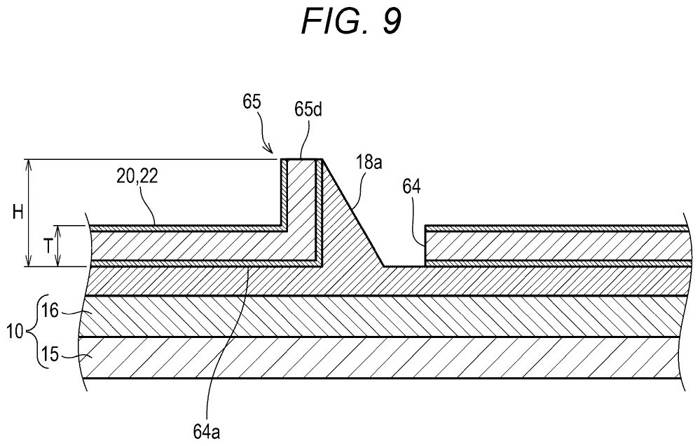

Next, a projecting portion 65 according to a second embodiment, which projects upward from part of the edge of a through-hole 64, will be described with reference to FIGS. 8 and 9.

FIG. 8 is a schematic perspective view showing the projecting portion 65 and the through-hole 64 according to the second embodiment. FIG. 9 is an end view showing the projecting portion 65 and a fillet 18a along an IX-IX line in FIG. 8.

The through-hole 64 according to the present embodiment has an extending portion 64a. The extending portion 64a extends from the edge of the through-hole 64 to the center of the through-hole 64 in the direction of the surface of a metal piece (metal plate 20). The through-hole 64 has, on both sides of the extending portion 64a, slits 64b formed along the direction of extension of the extending portion 64a. The projecting portion 65 is formed at the extending end of the extending portion 64a. Note that the “direction of the surface of the metal piece (metal plate 20)” indicates an arbitrary direction in a plane including the lateral and depth directions in FIG. 9.

Specifically, the through-hole 64 according to the present embodiment is formed in an elongated C-shape with angular corners in plan view (as viewed in the thickness direction) as shown in FIG. 8. Both ends of the C-shaped through-hole 64 are the slits 64b, and the extending portion 64a is formed between the slits 64b. The projecting portion 65 extending upward in the thickness direction is provided at the extending end of the extending portion 64a (see FIG. 9).

By the projecting portion 65 being formed at the extending end of the extending portion 64a as described above, stress concentration when the projecting portion 65 is bent to one side (upper side in the example of FIG. 9) in the thickness direction can be suppressed as compared to a case where the projecting portion 65 is formed so as to project in the thickness direction from the edge of the through-hole 64 without the extending portion 64a. For example, according to the configuration of the present embodiment, it is possible to suppress the occurrence of not-shown wrinkle-like bulges due to stress concentration on the metal plate 20 in the vicinity of the slits 64b on both sides of the projecting portion 65.

However, the present disclosure is not limited to such a configuration, and the slits 64b are not necessarily formed on both sides of the projecting portion 65. That is, the extending portion 64a extending from the edge of the through-hole 64 to the center of the through-hole 64 in the direction of the surface of the metal piece is not necessarily formed, and the projecting portion 65 may be formed so as to directly project upward from the edge of the through-hole 64.

The through-hole 64 has been described as the elongated C-shaped hole with angular corners, but may be in a quadrangular shape or other shapes. When in a through-hole 64 formed as such, the projecting portion 65 is formed from a portion of the longitudinal edge of the through-hole 64, it is preferable because a wide region where the fillet 18a is formed can be ensured.

The example where the projecting portion 65 is formed at part (extending portion 64a) of the edge of the through-hole 64, but the present disclosure is not limited thereto. The projecting portion 65 may be formed at a plurality of portions of the edge of the through-hole 64. According to this configuration, fillets 18a can be easily formed at the plurality of portions at which the projecting portions 65 are formed. Thus, at these portions, the connection strength can be enhanced. Further, at these portions, the quality of connection with solder can be determined.

The standing height H of the projecting portion 65 shown in FIG. 9 is preferably within a range of 1.25 times or more and 5 times or less a thickness T of the metal piece (metal plate 20).

The “standing height H” indicates a height from the lower surface (surface facing the land 16) of the protruding portion 22 to the end surface 65d of the projecting portion 65 as shown in FIG. 9.

According to the above-described configuration, the standing height H of the projecting portion 65 is limited to 1.25 times or more, and therefore, the region where the fillet 18a is formed can be sufficiently ensured. Moreover, the standing height H of the projecting portion 65 is limited to 5 times or less, and therefore, it is possible to suppress formation of an unnecessary portion without the fillet 18a at a plated portion provided at the standing portion of the projecting portion 65.

Note that a relationship between the standing height H of the projecting portion 65 and the thickness T of the metal plate 20 is preferably similar to a relationship between the height of each of the projecting portion 25, the lowest portion 35g of the projecting portion 35, the projecting portion 45, and the projecting portion 55 according to the first embodiment and the thickness T of the metal plate 20.

Note that various components of the wiring module 100 of the present disclosure are not necessarily independent of each other. The present disclosure includes, e.g., a plurality of components being formed as one member, one component being formed by a plurality of members, a certain component being part of another component, and a certain component partially overlapping with part of another component.

The present embodiment includes the following technical ideas.

(1) A wiring module including:
a flexible printed board; and a metal piece,
in which the flexible printed board has a land and a wiring connected to the land,
the metal piece has an upper surface, a lower surface, a through-hole, and a projecting portion,
the lower surface of the metal piece is solder-joined to the land,
the through-hole is formed inside an outer peripheral edge of the metal piece in a thickness direction of the metal piece,
the projecting portion is formed so as to project from at least part of an edge of the through-hole to above the upper surface of the metal piece,
the projecting portion has a plated portion and a non-plated portion,
the plated portion is provided at an inner peripheral surface of the projecting portion facing the through-hole, and
the non-plated portion is provided at an end surface of a projecting end of the projecting portion.
   (2) The wiring module according to (1), in which
the projecting portion is formed over an entire circumference of the edge of the through-hole,
the plated portion is provided over an entire circumference of the inner peripheral surface of the projecting portion, and
the non-plated portion is provided over an entire circumference of the end surface of the projecting end of the projecting portion.
   (3) The wiring module according to (1) or (2), in which a portion of the projecting portion having a lowest projecting height is provided opposite to a portion of the projecting portion having a highest projecting height with respect to a center of the through-hole in plan view.
   (4) The wiring module according to any one of (1) to (3), in which the end surface of the projecting portion is formed to be inclined so as to approach the land in the thickness direction as extending toward the center of the through-hole.
   (5) The wiring module according to any one of (1) to (4), in which a groove extending in the projecting direction of the projecting portion is formed in the inner peripheral surface of the projecting portion, and the groove is formed shallower than a thickness of the plated portion.
   (6) The wiring module according to (1), or (4) or (5) that cites (1), in which the through-hole has an extending portion and a slit, the extending portion is provided so as to extend from the edge of the through-hole toward a center of the through-hole, the slit is formed on both sides of the extending portion along a direction of extension of the extending portion, and the projecting portion is formed at an extending end of the extending portion.
   (7) The wiring module according any one of (1) to (6), in which a standing height of the projecting portion in the thickness direction is within a range of 1.25 times or more and 5 times or less a thickness of the metal piece, and the standing height is a height from the lower surface of the metal piece to the end surface of the projecting portion.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A wiring module comprising:
a flexible printed board; and
a metal piece,
wherein the flexible printed board has a land and a wiring connected to the land,
the metal piece has an upper surface, a lower surface, a through-hole, and a projecting portion,
the lower surface of the metal piece is solder-joined to the land,
the through-hole is formed inside an outer peripheral edge of the metal piece in a thickness direction of the metal piece,
the projecting portion is formed so as to project from at least part of an edge of the through-hole to above the upper surface of the metal piece,
the projecting portion has a plated portion and a non-plated portion,
the plated portion is provided at an inner peripheral surface of the projecting portion facing the through-hole, and
the non-plated portion is provided at an end surface of a projecting end of the projecting portion.

2. The wiring module according to claim 1, wherein
the projecting portion is formed over an entire circumference of the edge of the through-hole,
the plated portion is provided over an entire circumference of the inner peripheral surface of the projecting portion, and
the non-plated portion is provided over an entire circumference of the end surface of the projecting end of the projecting portion.

3. The wiring module according to claim 1, wherein
a portion of the projecting portion having a lowest projecting height is provided opposite to a portion of the projecting portion having a highest projecting height with respect to a center of the through-hole in plan view.

4. The wiring module according to claim 3, wherein
the end surface of the projecting portion is formed to be inclined so as to approach the land in the thickness direction as extending toward the center of the through-hole.

5. The wiring module according to claim 1, wherein
the through-hole has an extending portion and a slit,
the extending portion is provided so as to extend from the edge of the through-hole toward a center of the through-hole,
the slit is formed on both sides of the extending portion along a direction of extension of the extending portion, and
the projecting portion is formed at an extending end of the extending portion.

6. The wiring module according to claim 5, wherein
a standing height of the projecting portion in the thickness direction is within a range of 1.25 times or more and 5 times or less a thickness of the metal piece, and the standing height is a height from the lower surface of the metal piece to the end surface of the projecting portion.
